(19) United States
(12) Patent Application Publication
(10) Pub. No.: US 2015/0052170 A1
(43) Pub. Date: Feb. 19, 2015

(54) METHOD, SEARCH METHOD, AND STORAGE MEDIUM

(71) Applicant: FUJITSU LIMITED, Kawasaki-shi (JP)

(72) Inventors: Takahiro MURATA, Yokohama (JP); Takafumi OHTA, Shinagawa (JP); Masahiro KATAOKA, Tama (JP); Masanori SAKAI, Mishima (JP)

(73) Assignee: FUJITSU LIMITED, Kawasaki-shi (JP)

(21) Appl. No.: 14/527,172

(22) Filed: Oct. 29, 2014

Related U.S. Application Data
(63) Continuation of application No. PCT/JP2012/003390, filed on May 24, 2012.

(51) Int. Cl. G06F 17/30

(52) U.S. Cl. CPC G06F 17/30106; G06F 17/30091
USPC 707/769; 707/821

(57) ABSTRACT

A method includes: storing, by a processor, in a storage region represented by first character information and identification information of a first file, presence or absence information that represents whether or not the first file includes the character information or whether or not a second file that is different from the first file includes second character information, wherein the storage region stores information that represents whether or not the second file includes the second character information.

### CROSS-REFERENCE TO RELATED APPLICATION

This application is a continuation application of International Application PCT/JP2012/003390 filed on May 24, 2012, the entire contents of which are incorporated herein by reference.

### FIELD

The embodiments discussed herein are related to a search technique.

### BACKGROUND

Regarding a full-text search, a technique for narrowing down files to be searched using index information of correspondence relationships representing whether or not character information within each character string to be searched is included in any of the files is known. For example, when certain character information C is included in a character string to be searched, a file for which index information generated in advance represents that the file includes the character information C is to be subjected to a character string search based on the character string. On the other hand, it is apparent that a file for which the index information represents that the file does not include the character information C does not include the character string to be searched, even if the file is not subjected to the character string search. Thus, the file for which the index information represents that the file does not include the character information C is excluded from files to be subjected to the character string search.

Index information that represents, based on values of bits assigned to files, whether or not each character information item is included in any of the files is known. In the index information, each bit string of bits arranged in order of file numbers is associated with to a respective character information item. A file with a file number associated with a bit of a value “1” among a bit string includes a character information item associated with the bit string. On the other hand, a file with a file number associated with a bit of a value “0” among the bit string does not include the character information item associated with the bit string.

Bit strings are associated with character information items, respectively. Thus, when the number of types of character information items indicated by the index information is increased, the data size of the index information increases. A technique for using index information in which each bit string is associated with character information items of multiple types is known. In this case, a file with a file number associated with a bit of a value “1” includes at least one of multiple types of character information items associated with a bit string including the bit. A file with a file number associated with a bit of a value “0” does not include any of multiple types of character information items associated with a bit string including the bit. Values (addresses) are assigned to the bit strings. An address that represents a bit string associated with a character information item is obtained by substituting the character information item into a hash function. Thus, character information items that enable the same value to be obtained by substituting the character information items into the hash function are associated with the same bit string.

If index information in which each bit string is associated with multiple character information items is used, noise may occur in a process of narrowing files down to files to be subjected to the character string search. This is due to the fact that, even if a bit that is included in a bit string associated with a character information item CA included in a character string to be searched has a value “1”, a file with a file number associated with the bit of the value “1” may not include the character information item CA and may include another character information item CB. A value that is obtained by substituting the character information item CA into the hash function is the same as a value obtained by substituting the character information item CB into the hash function. In this case, a file that does not include the character information item CA and has a file number associated with a bit of the value “1” is to be subjected to the character string search.

On the other hand, a technique for using index information of multiple types is known. In the index information of the multiple types, character information items are associated with bit strings using different hash functions. In the aforementioned example, the character information item CA and the character information item CB are associated with the same bit string. In the technique for using the index information of the multiple types, the character information item CA and the character information item CB are associated with different bit strings using the different hash functions. Files are narrowed down to files to be subjected to the character string search using the index information of the multiple types, based on a bit string obtained by calculating logical products (AND) of bit strings associated with the character information item CA and included in the index information of the multiple types. If a bit that is associated with the character information item CA and a certain file number has the value “1” in certain index information, and a bit that is associated with the character information item CA and the certain file number has the value “0” in the other index information, a bit that is obtained by calculating a logical product of the bits has the value “0”. Thus, the index information of the multiple types represents that a file with the file number associated with the bit does not include the character information item CA. Even if it may not be determined that the file does not include the character information item CA due to the presence of the character information item CB associated with the same bit string in the certain index information, it may be determined that the file does not include the character information item CA by using the other index information.

As examples of related art, Japanese Laid-open Patent Publication Nos. 2011-138230 and 3-125263 are known.

### SUMMARY

According to an aspect of the invention, a method includes: storing, by a processor, in a storage region represented by first character information and identification information of a first file, presence or absence information that represents whether or not the first file includes the character information or whether or not a second file that is different from the first file includes second character information, wherein the storage region stores information that represents whether or not the second file includes the second character information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A illustrates an example of index information;

FIG. 1B illustrates an example of the calculation of logical products of bit strings within the index information;

FIG. 2 describes a process of narrowing down files using index information of multiple types;

FIG. 3A illustrates an example of an argument to be substituted into a function;

FIG. 3B illustrates an example of index information;

FIG. 4 illustrates an example of functional blocks of a computer;

FIG. 5 illustrates an example of functional blocks of a generation unit;

FIG. 6 illustrates an example of functional blocks of a narrowing-down unit;

FIG. 7 illustrates an example of a hardware configuration of the computer;

FIG. 8 illustrates an example of a software configuration of the computer;

FIG. 9 illustrates an example of a procedure for a process of generating index information;

FIG. 10 illustrates an example of a procedure for a process of executing a full-text search;

FIG. 11 illustrates an example of a procedure for a process of referencing index information;

FIG. 12 illustrates correspondence relationships between file numbers and file paths;

FIG. 13 illustrates a table storing the positions of parts that match a character string to be searched;

FIGS. 14A, 14B, 14C, and 14D illustrate correspondence relationships between character information items and addresses;

FIGS. 15A and 15B illustrate relationships of index information of two types; and

FIG. 16 illustrates relationships of presence and absence information of character information items of which addresses overlap each other.

### DESCRIPTION OF EMBODIMENTS

Even if the aforementioned index information of the multiple types is used, noise may occur in the narrowing-down process. A character information item CC associated with the same bit string as the character information item CA may exist in the other index information item described in the aforementioned example. When a file that does not include the character information item CA and includes the character information item CC exists, a bit that is associated with the file and the character information item CA has the value “1” in the other index information item. If the values of the bits associated with the character information item CA are 1 in both index information items, the logical product (AND) of the bits is “1”. As indicated in the example, a logical product (AND) of bits included in both index information items and associated with a file that does not include the character information item CA and includes the character information items CB and CC is “1”. Thus, in a process of narrowing down files for the character information item CA, a file that does not include the character information item CA may be a file to be subjected to the character string search. In other words, the noise may occur in the narrowing-down process. As described above, if a single bit string is associated with a plurality of character information items, noise may occur in the narrowing-down process due to the presence of another character information item included in the same file.

The number of types of character information items included in each of files depends on the file. For example, the number of types of character information items included in an index part of an academic book tends to be large. On the other hand, a file that includes a smaller number of types of character information items than a file of the index part exists among files of a body of the academic book. If the number of types of character information items included in a file is small, the following fact hardly occurs: index information does not represent the absence of the other character information item within the file due to the presence of a certain character information item associated with the same bit string as another character information item in the file. A file that includes a larger number of types of character information items than the aforementioned file may be easily noise in the narrowing-down process due to the presence of the certain information item within the same file, compared with a file including a small number of types of character information items.

According to an aspect of the disclosure, regardless of the fact that a file does not include a character information item within a character string to be searched, the following fact is suppressed: the file is determined to be subjected to a character string search due to the presence of another character information item included in the same file.

First, a process of narrowing down files to be searched using index information is described.

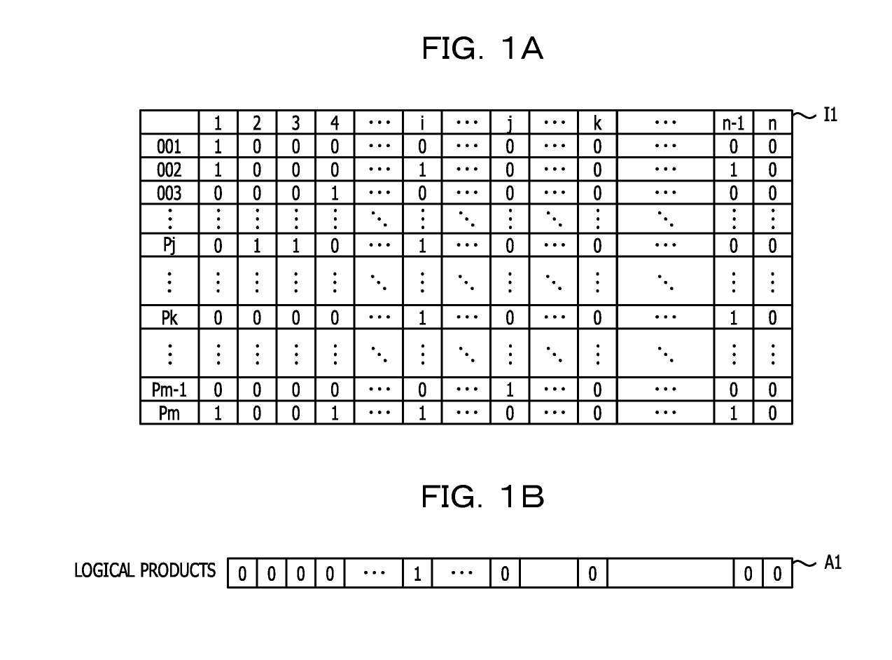

FIG. 1A illustrates index information I1 based on files F1 to Fn to be searched. In the index information I1 illustrated in FIG. 1A, the uppermost row represents file numbers. The file numbers are associated with the files F1 to Fn to be searched. In the index information I1, character information items C1 to Cm are associated with bit strings that represent whether or not the character information items exist in the files F1 to Fn.

A character information item Cj that is included in the character information items C1 to Cm is, for example, a character string formed of a single character or formed by combining a plurality of characters. Alternatively, the character information item Cj may be a part of a binary code corresponding to the character information item. The character information items C1 to Cm may be all combinations of characters (for example, characters to which JIS codes are assigned) expected to be used. For example, it is assumed that a certain file Fi (with a file number i) among the files F1 to Fn includes a character string “ [symbol] [symbol] [symbol] [symbol] [symbol] ”. In this case, the file Fi includes character information items “ [symbol] ”, “ [symbol] ”, “ [symbol] ”, . . . , “ [symbol] ”. In addition, the file Fi includes character information items “ [symbol] ”, “ [symbol] ”, “ [symbol] ”, . . . , “ [symbol] ”. Embodiments assume that each of the character information items C1 to Cm is a character information item of two characters.

Whether or not the character information item Cj is included in any of the files F1 to Fn is represented by storing, in a storage region associated with the character information item Cj and a file Fi among the files F1 to Fn, information representing whether or not the character information item Cj is included in the file Fi. In this case, a number i is in a range of 1 to n. For example, a position at which the presence or absence information that represents whether or not the character information item Cj is included in the file Fi is stored in the index information I1 is represented by the file number i and an address Pj obtained by substituting a binary code corresponding to the character information item Ci into a hash function. If the binary code corresponding to the character information item Ci is a binary code (character code based on JIS) corresponding to the character information item “ [symbol] ”, the binary code corresponding to the character information item Ci is 0x346E3760 (0x is represented by hexadecimal numbers), for example.

If the single address Pj is assigned to the single character information item Cj, and the character information item Cj exists in the file Fi, the presence or absence information of the character information item Cj is represented by a bit of a value “1”. If the single address Pj is assigned to the single character information item Cj, and the character information item Cj does not exist in the file Fi, the presence or absence information of the character information item Cj is represented by a bit of a value “0”. On the other hand, the single address Pj may be assigned to a plurality of character information items (for example, the character information item Cj and a character information item Ck). In this case, if at least one of the character information item Cj and the character information item Ck exists in the file Fi, presence or absence information of the character information items Cj and Ck is represented by a bit of the value “1”. If both character information item Cj and character information item Ck do not exist in the file Fi, the presence or absence information of the character information items Cj and Ck is represented by a bit of the value “0”. Details of presence or absence information may be changed. For example, information that represents that a character information item does not exist may be represented by a bit of the value “1”, while information that represents that the character information item exists may be represented by a bit of the value “0”. Furthermore, information that represents whether or not a character information item exists may be represented by a plurality of bits. In the index information illustrated in FIG. 1A, files that each include a character information item are each represented by a bit of the value “1”.

For example, if a character information item associated with the address Pj is only “ [symbol] ”, it is apparent, based on a bit string represented by the address Pj in the index information I1, that the character information item “ [symbol] ” is included in files with file numbers 2, 3, and i. In addition, for example, if character information items “ [symbol] ” and “ [symbol] ” are associated with a single address Pk, a bit string represented by the address Pk in the index information I1 represents that each of the files F1 to Fn includes at least one of the character information items “ [symbol] ” and “ [symbol] ” or does not include both character information items “ [symbol] ” and “ [symbol] ”. For example, the index information illustrated in FIG. 1A represents that files with file numbers i and n−1 each include at least one of the character information items “ [symbol] ” and “ [symbol] ” and that files with file numbers 1, 2, 3, j, k, and the like do not include both character information items “ [symbol] ” and “ [symbol] ”.

As illustrated in FIG. 1A, since the file Fi includes the character information item “ [symbol] ” and other character information items, a bit located at a position associated with the character information item “ [symbol] ” and bits located at positions associated with the other character information items “ [symbol] ”, “ [symbol] ”, and the like have the value “1”. Bits located at positions associated with character information items included in the files F1 to Fn have the value “1”, although those bits are omitted in FIG. 1A.

In order to search the files F1 to Fn, the files are narrowed down to files to be subjected to the character string search, using the index information I1 illustrated in FIG. 1A. For example, it is assumed that a search request that includes a character string “ [symbol] ” to be searched is received. The character string “ [symbol] ” includes the character information items “ [symbol] ” and “ [symbol] ”. In this case, the files are narrowed down to files to be subjected to the character string search, based on a bit string represented by the address (Pj illustrated in FIG. 1A) calculated based on the character information item “ [symbol] ” and a bit string represented by the address (Pk illustrated in FIG. 1A) calculated based on the character information item “ [symbol] ”. For example, a bit string A1 that is a result obtained by calculating logical products of the bit string associated with the address Pj and the bit string associated with the address Pk is illustrated in FIG. 1B.

In the bit string A1 illustrated in FIG. 1B, a file (file with a file number i in FIG. 1B) that is associated with a bit of a value “1” is a file to be subjected to the character string search. In an example illustrated in FIG. 1A, the plurality of character information items (for example, “ [symbol] ” and “ [symbol] ”) are associated with the address Pk. The file Fi does not include the character information item “ [symbol] ”, but includes the character information item “ [symbol] ”. Thus, a bit that represents the file F1 and is included in a bit string associated with the address Pk associated with the character information items “ [symbol] ” and “ [symbol] ” has the value “1”. If the files to be searched are narrowed down using the index information I1 based on the character information items “ [symbol] ” and “ [symbol] ”, the file Fi is determined to be a file including the character information items “ [symbol] [symbol] ” and “ [symbol] ” and to be searched, regardless of the fact that the file Fi does not include the character information item “ [symbol] ”.

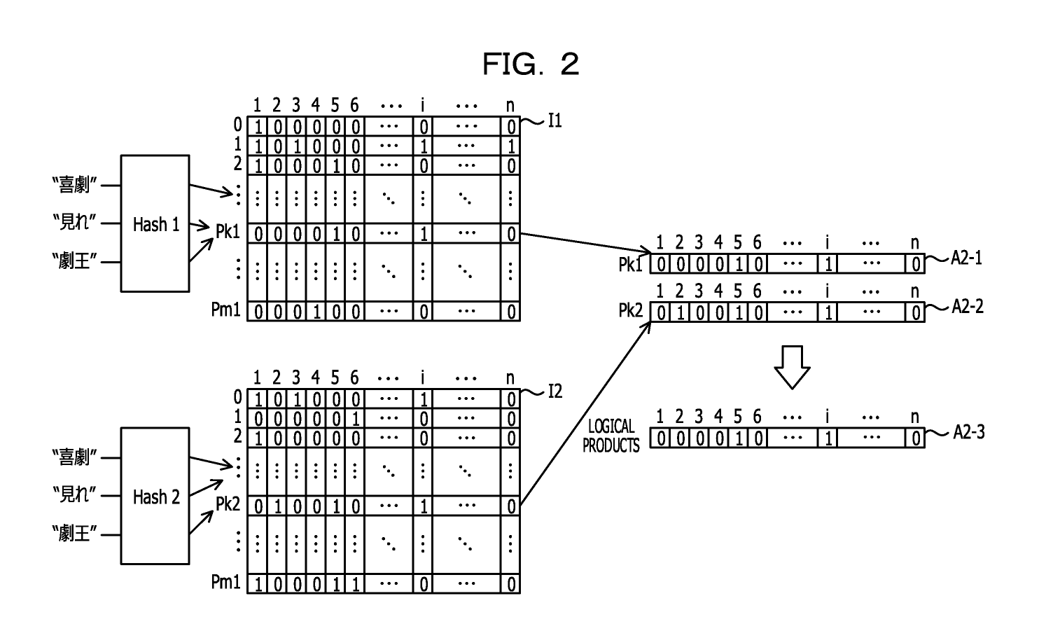

FIG. 2 is a diagram describing a process of narrowing down files using a plurality of index information items I1 and I2. As illustrated in FIG. 1A, in the index information I1, the character information items “ [symbol] ” and “ [symbol] ” are associated with the address Pk (Pk2 in an example illustrated in FIG. 2). This is due to the fact that a value obtained by substituting the character information items “ [symbol] ” and “ [symbol] ” into the hash function (hash function Hash 1 in the example illustrated in FIG. 2) is an address Pk1. For example, it is assumed that when a hash function Hash 2 that is different from the hash function Hash 1 is used, an index information item I2 is generated. In the index information item I2, the character information item “ [symbol] ” is associated with the address Pk1. In addition, the character information item “ [symbol] ” is associated with an address that is different from an address Pk2.

In order to search the character string “ [symbol] ”, the files are narrowed down to files to be subjected to the character string search, based on presence or absence information that is related to the character information item “ [symbol] ” and included in the index information items I1 and I2. For example, a bit string A2-1 of the address Pk1 and a bit string A2-2 of the address Pk2 are extracted, and the files are narrowed down based on a bit string A2-3 obtained by calculating logical products of the extracted bit strings. In the index information item I2, however, a character information item other than the character information item “ [symbol] ” may be associated with the address Pk2. In the index information item I2 illustrated in FIG. 2, a corresponding bit has the value “1” regardless of the fact that the file Fi does not include the character information item “ [symbol] ”. If the file Fi includes a character information item that is not the character information item “ [symbol] ” and is associated with the address Pk2, the fact that the file Fi does not include the character information item “ [symbol] [symbol] ” is not represented in the index information item I2. Thus, the fact that the file Fi does not include the character information item “ [symbol] ” is not represented in the bit string A2-3 generated based on the index information items I1 and I2. Thus, regardless of the fact that the file Fi does not include the character information item “ [symbol] ”, the files are narrowed down to files including the file Fi that is to be subjected to the search of the character string “ [symbol] ”.

The same applies to a case where one-byte characters are used. For example, it is assumed that the file Fi includes a character string “Life is a tragedy when seen in close-up, but a comedy in long-shot.”. A bit, which is located at a position represented by the file number i and an address Pj calculated based on a character information item “come”, has the value “1” in index information, for example. In addition, a bit, which is located at a position represented by the file number i and an address Pk calculated based on a character information item “medy”, has the value “1” in the index information, for example. It is assumed that if a character string to be searched is “comedian”, files to be searched are narrowed down to a file including the character information items “come” and “dian” based on the index information. In this case, if an address calculated based on the character information item “dian” is accidently the same as the address Pk calculated based on the character information item “medy”, the file Fi is to be subjected to the search of the character string “comedian”, regardless of the fact that the file Fi does not include the character information item “dian”.

In addition, there is a method for generating the plurality of index information items I1 and I2 using the plurality of hash functions Hash 1 and Hash 2 for associating addresses with character information items. The character information items “medy” and “dian” are accidently associated with the same address in the index information item I1, but are associated with different addresses in the index information item I2 using the hash function Hash 2 different from the hash function Hash 1 used for the index information item I1. Referencing the index information item I2 suppresses the fact that the files to be searched are narrowed down to files including the file Fi due to the presence of the character information item “medy” in the file Fi, regardless of the fact that the file Fi does not include the character information item “dian”. Regarding the index information item I2, however, the files to be searched are narrowed down to files including the file Fi that includes the character information item associated with the same address as the character information item “dian”, regardless of the fact that the file Fi does not include the character information item “dian”.

As described above, noise may occur in the process of narrowing down files due to overlapping of addresses associated with different character information items. This is due to the fact that pointers that represent storage positions of the absence of character information items (“ [symbol] ”, “dian”, and the like) that are not included in the file Fi overlap pointers that represent storage positions of the presence of character information items (“ [symbol] ”, “medy”, and the like) that are included in the file Fi. Since bits have the value “1” due to the presence of the character information items (“ [symbol] ”, “medy”, and the like) included in the file Fi, the index information items do not represent that the character information items (“ [symbol] ”, “dian”, and the like) that are not included in the file Fi do not exist. If a corresponding pointer does not include a plurality of overlapping character information items, a bit has the value “0”. It is, therefore, apparent that the index information items represent that the plurality of character information items do not exist.

Specifically, as the probability that a pointer of a character information item included in a file and a pointer of a character information item that is not included in the file overlap each other increases, noise more easily occurs in the narrowing-down process. For example, regarding an electronic book such as an academic book, a file of an index and a file of a table of contents tend to have a larger number of types of character information items than a file of a body of the book. The numbers of types of character information items included in files of the same electronic book may be different. Regarding files in which the numbers of types of character information items are different, the fact that index information does not represent the absence of a character information item within one of the files due to overlapping of addresses more easily occur than the other file.

For the aforementioned reason, if index information of the files F1 to Fn is an entirely sparse matrix, a file including a large number of character information items may easily be noise in the narrowing-down process due to overlapping of pointers of character information items. An example of the file including the large number of character information items is a file of which the size is larger than the other files. If the file with the large size is noise in the narrowing-down process, the amount of processing for a meaningless character string search is larger than the other files.

### First Embodiment

A first embodiment is described below. In the first embodiment, each address included in an index information item is calculated by calculating a function f using, as an argument, a value calculated based on a character information item Cj and a file Fi with a file number i. Presence or absence information that represents whether or not the character information item Cj exists in the file Fi is stored at a calculated address Pij. The function f returns values that are in a predetermined range.

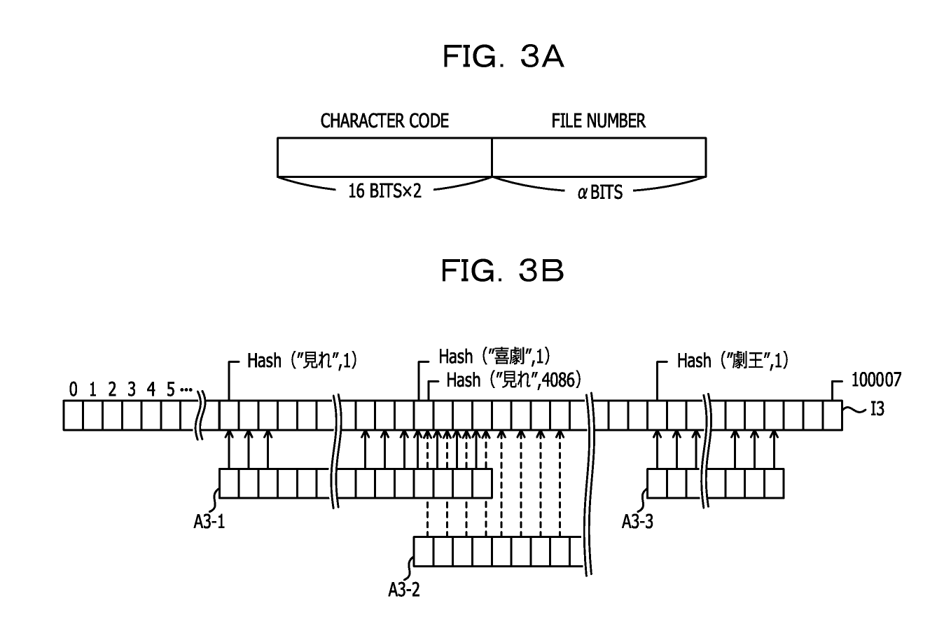

FIG. 3A illustrates an example of the argument to be substituted into the function f. In the example illustrated in FIG. 3A, the argument is a sum of a binary code obtained by shifting a binary code of the character information item Ci by a predetermined number α and a binary code of the file number i of the file Fi. The character information item Ci, the file number i, and the argument are, for example, binary codes. For example, if the character information item Cj is “ [symbol] ”, the binary code of the character information item Cj is “0x346E3760” (if JIS codes are used as character codes). If the file number is “52” (represented by decimal numbers), the binary code of the file number is “0x34”. As exemplified in FIG. 3A, if the predetermined number α is 16 and the character information item Cj is shifted by 16 bits, the argument is “0x346E37600034”, for example.

FIG. 3B illustrates an index information item I3. For example, a value obtained by substituting the argument illustrated in FIG. 3A into the function f represents a position at which presence or absence information that represents whether or not the character information item Cj exists in the file Fi is stored, or the value is an address within the index information item I3. For example, it is assumed that the function f is a function for calculating a remainder obtained by dividing the argument by a certain divider D. A case where the function f is another function is described later. For example, if the divider D is “100007” (represented by decimal numbers), the obtained value is a number in a range of 0 to 100006, and the index information item I3 is stored in a storage region of 100007 bits. In this case, the argument is “0x346E37600034” (represented by hexadecimal numbers) as described above, and the remainder obtained from the division by “100007” is “9150” (represented by decimal numbers). Thus, presence or absence information that represents whether or not the character information item “ [symbol] ” exists in a file F52 with a file number “52” is stored in a storage region associated with “9150”. In FIG. 3B, an address that is calculated based on the character information item “ [symbol] ” and the file number i is represented by Hash (“ [symbol] ”, 1). Similarly, a binary code of the character information item “ [symbol] ” is “0x382B246C”, and an address of the binary code is “5064” (represented by decimal numbers). As illustrated in FIG. 3B, Hash (“ [symbol] ”, 1) and Hash (“ [symbol] ”, 4086) are the same value, and presence or absence information that represents whether or not the character information item “ [symbol] ” exists in the file F1, and presence or absence information that represents whether or not the character information item “ [symbol] ” exists in a file F4086, overlap each other and are stored in a storage region represented by the aforementioned same value. Specifically, a logical sum of bits representing the presence or absence of the character information items is stored.

For example, presence or absence information that represents whether or not the character information item “ [symbol] ” exists in a file F53 with a file number “53” larger by 1 than “52” is stored in a storage region associated with “9151” that is larger by 1 than the address “9150” at which the presence or absence information that represents whether or not the character information item “ [symbol] ” exists in the file F52 is stored. Since the file number is not shifted by a bit in the argument illustrated in FIG. 3A, addresses that are calculated using remainders and at which presence or absence information that represents whether or not the same character information item “ [symbol] ” exits is stored are continuous. For example, an address at which presence or absence information that represents whether or not the character information item “ [symbol] ” in a file with a file number 0 is stored is calculated to be “9098”. Addresses at which presence or absence information that represents whether or not the character information item “ [symbol] ” exists in the files F1 to Fn corresponding to the file numbers 1 to n is stored are continuous values in a range from “9098+1” to “9098+n”. As illustrated in FIG. 3B, a bit string A3-2 that represents whether or not the character information item “ [symbol] ” exists in the files F1 to Fn is reflected in bits located at corresponding positions in the index information item I3. As illustrated in FIG. 3B, a bit string A3-1 that represents whether or not the character information item “ [symbol] ” exists in the files F1 to Fn is reflected in bits located at corresponding positions in the index information item I3. Although a part of a region in which the bit string A3-1 is reflected, and a part of a region in which the bit string A3-2 is reflected, overlap each other in the index information item I3, logical sums of the bit strings A3-1 and A3-2 are stored in the overlapping part as described above.

Addresses of presence or absence information that represents whether or not one-byte character information items exist are determined by the same method. For example, a binary code of the character information item “come” is “0x636d6b65”. For example, if presence or absence information that represents whether or not the character information item “come” exists in the file F52 is to be stored, an argument to be used for the calculation of the address is “0x636d6b650034”. In addition, a remainder obtained by dividing “0x636d6b650034” by “100007” is “89727” (represented by decimal numbers). Thus, the presence or absence information that represents whether or not the character information item “come” exists in the file F52 is stored in a storage region associated with “89727”.

In the first embodiment, the generation of the index information item and the process of narrowing the files down to files to be subjected to the character string search are executed using addresses within the index information item defined by the aforementioned method. The generation of the index information item according to the first embodiment and the process of narrowing the files down to files to be subjected to the character string search according to the first embodiment are described below in detail.

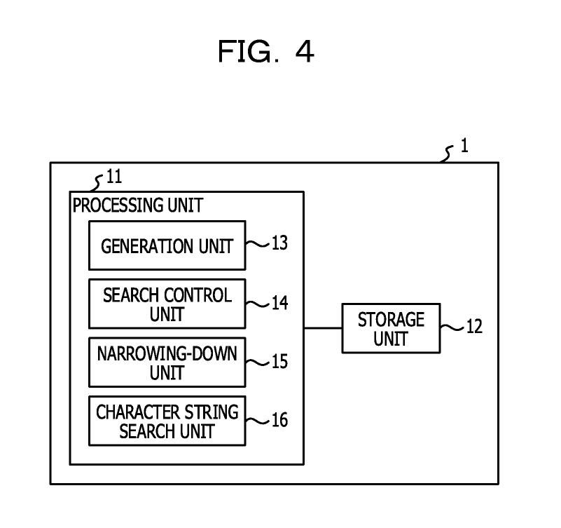

FIG. 4 illustrates an example of functional blocks of a computer 1 according to the first embodiment. The computer 1 includes a processing unit 11 and a storage unit 12. The processing unit 11 generates the index information item and executes a search using the generated index information item. The storage unit 12 stores information (for example, the files F1 to Fn to be searched, the index information item, and the like) to be used for a process to be executed by the processing unit 11.

The processing unit 11 includes a generation unit 13. The generation unit 13 generates the index information item and causes the generated index information item to be stored in the storage unit 12.

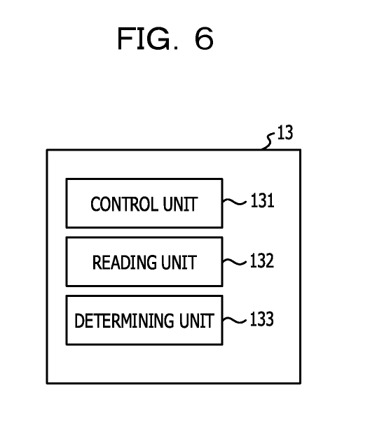

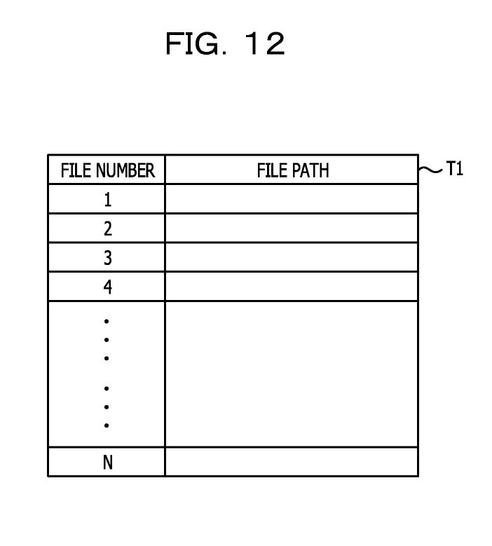

FIG. 6 illustrates an example of functional blocks of the generation unit 13. The generation unit 13 includes a control unit 131, a reading unit 132, and a determining unit 133. The control unit 131 sequentially identifies the files F1 to Fn in order from the file F1 to the file Fn and causes the reading unit 132 and the determining unit 133 to execute processes on the identified files. The reading unit 132 reads a file Fi identified by the control unit 131 from the storage unit 12. The determining unit 133 determines, for each of character information items Cj among the character information items C1 to Cm, whether or not the file Fi includes the character information item Cj. If a result of the determination made by the determining unit 133 represents that the file Fi includes the character information item Cj, the control unit 131 calculates an address based on the character information item Cj and the file number i of the file Fi and causes information representing that the file Fi includes the character information item Cj to be stored at a storage position represented by the calculated address. FIG. 12 illustrates an example of a table T1 storing correspondence relationships between the file numbers and file paths. When a file number is identified by the control unit 131, the reading unit 132 reads a file path associated with the identified file number in the table T1 and identifies a file with the identified file number.

As illustrated in FIG. 4, the processing unit 11 includes a search control unit 14, a narrowing-down unit 15, and a character string search unit 16. The search control unit 14 controls the narrowing-down unit 15 and the character string search unit 16 so as to execute a search process in accordance with a search request. The narrowing-down unit 15 uses the index information item illustrated in FIG. 3B to narrow down files to be searched. For example, the search control unit 14 extracts a character information item Ca from a character string included in a received search request and to be searched and notifies the narrowing-down unit 15 of the extracted character information item Ca. The narrowing-down unit 15 notifies the search control unit 14 of file numbers of files excluding a file that does not include the character information item Ca notified by the search control unit 14. The character string search unit 16 executes the character string search on the files to which the narrowing-down unit 15 has narrowed down the files, based on the search request received by the search control unit 14.

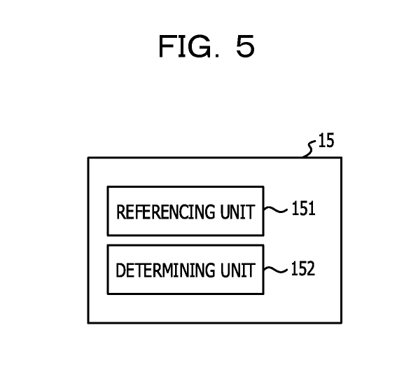

FIG. 5 illustrates an example of functional blocks of the narrowing-down unit 15. The narrowing-down unit 15 includes a referencing unit 151 and a determining unit 152. The referencing unit 151 reads a part that is included in the index information item stored in the storage unit 12 and is associated with the character information item Ca notified by the search control unit 14. An address that represents the part associated with the character information item Ca is calculated based on the character information item Ca and a file number, as illustrated in FIG. 3B. If addresses of presence or absence information that represents whether or not the character information item Ca exists in the files F1 to Fn are continuous as represented by the index information item illustrated in FIG. 3B, the referencing unit 151 calculates an address using a file number “1” and reads a bit string of continuous n bits from the calculated address, for example. The determining unit 152 determines, based on the bit string read by the referencing unit 151, a file that does not include the character information item Ca. Then, the determining unit 152 notifies the character string search unit 16 of file numbers of files that are among the files F1 to Fn and exclude the file that does not include the character information item Ca.

The search control unit 14 may extract a plurality of character information items (for example, the character information item Ca and a character information item Cb) from a character string to be searched. The referencing unit 151 reads parts included in the index information item and associated with the plurality of character information items Ca and Cb. In addition, the determining unit 152 calculates logical products (AND) of presence or absence information included in a bit string associated with the character information item Ca and presence or absence information included in a bit string associated with the character information item Cb and determines, based on the results of the calculation, whether or not the character information items Ca and Cb exist in each of the files. The narrowing-down unit 15 does not notifies the character string search unit 16 of a file number of a file determined not to include any of the character information items Ca and Cb.

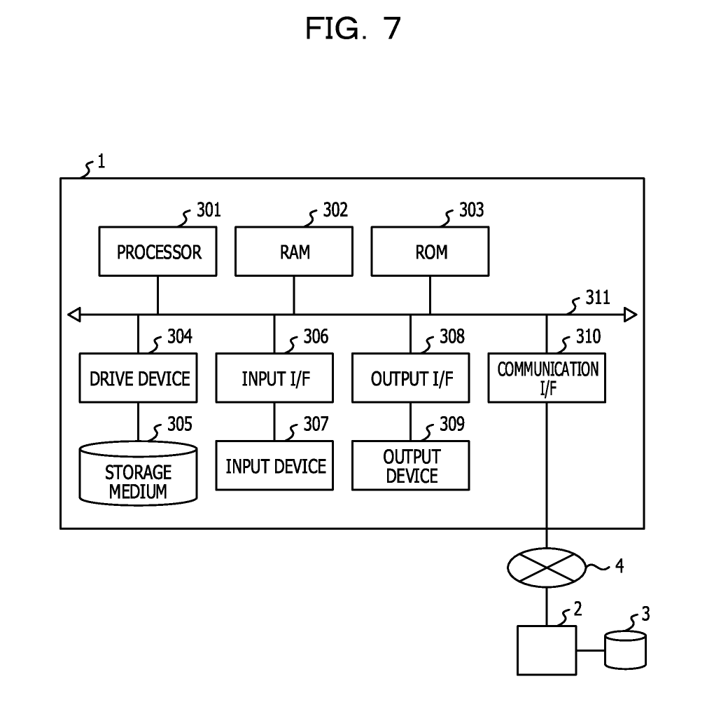

FIG. 7 illustrates an example of a hardware configuration of the computer 1. The functional blocks illustrated in FIGS. 4 to 6 are achieved by the hardware configuration illustrated in FIG. 7, for example. The computer 1 includes a processor 301, a random access memory (RAM) 302, a read only memory (ROM) 303, a drive device 304, a storage medium 305, an input interface (I/F) 306, an input device 307, an output interface (I/F) 308, an output device 309, and a communication interface (I/F) 309, for example. The hardware parts 301 to 310 are connected to each other through a bus 311. The communication interface 310 controls communication to be executed through the input device 307. The input interface 306 is connected to the input device 307 and transfers a signal received from the input device 307 to the processor 301. The output interface 308 is connected to the output device 309 and causes the output device 309 to execute outputting in accordance with an instruction from the processor 301.

The RAM 302 is a readable and writable memory device. As the RAM 302, a semiconductor memory such as a static RAM (SRAM) or a dynamic RAM (DRAM), a flash memory other than the RAMs, or the like may be used, for example. The ROM 303 includes a programmable ROM (PROM). The drive device 304 either reads or writes or both reads and writes information stored in the storage medium 305. The storage medium 305 stores information written by the drive device 304. The storage medium 304 is, for example, a hard disk, a compact disc (CD), a digital versatile disc (DVD), a Blu-ray disc, or the like. For example, the computer 1 may include a plurality of drive devices 304 and a plurality of storage media 305.

The input device 307 is configured to transmit an input signal in accordance with an operation. The input device 307 is, for example, a key device such as a keyboard or buttons attached to a body of the computer 1 or a pointing device such as a mouse or a touch panel. The output device 309 is configured to output information in accordance with control of the computer 1. The output device 309 is, for example, an image output device (display device) such as a display or an audio output device such as a speaker. Alternatively, an input and output device such as a touch screen may be used as the input device 307 and the output device 309, for example.

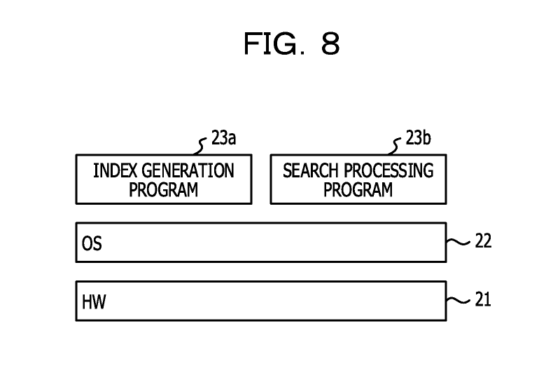

The processor 301 reads programs stored in the ROM 303 and the storage medium 305 into the RAM 302 and executes processes of the processing unit 11 in accordance with procedures of the read programs. In this case, the RAM 302 is used as a work area of the processor 301. A function of the storage unit 12 is achieved by causing the ROM 303 and the storage medium 305 to store the programs and the files F1 to Fn and causing the RAM 302 to be used as the work area of the processor 301. The programs to be read by the processor 301 are described below with reference to FIG. 8.

FIG. 8 illustrates an example of a configuration of software to be executed on the computer 1. An operating system (OS) 22 to be used to control a group 21 (illustrated in FIG. 7) of the hardware parts 301 to 310 is executed on the computer 1. The processor 301 operates so as to control and manage the hardware group 21 in accordance with a procedure based on the OS 22 and thereby causes the hardware group 21 to execute processes with an application program and middleware. In addition, in the computer 1, an index generation program 23a and a search processing program 23b are read into the RAM 302 and executed by the processor 301, for example. In addition, the functions of the generation unit 13 are achieved by causing the processor 301 to execute processes based on the index generation program 23a (or causing the processor 301 to control the hardware group 21 based on the OS 22 so as to execute the processes). Furthermore, functions of the search control unit 14, the narrowing-down unit 15, and the character string search unit 16 are achieved by causing the processor 301 to execute processes based on the search processing program 23b (or causing the processor 301 to control the hardware group 21 based on the OS 22 so as to execute the processes). Although FIG. 8 illustrates the index generation program 23a and the search processing program 23b as different programs, the index generation program 23a and the search processing program 23b may be combined so as to form a single program.

The configurations of the computer 1 illustrated in FIGS. 4 to 8 are the same as second and third embodiments described later.

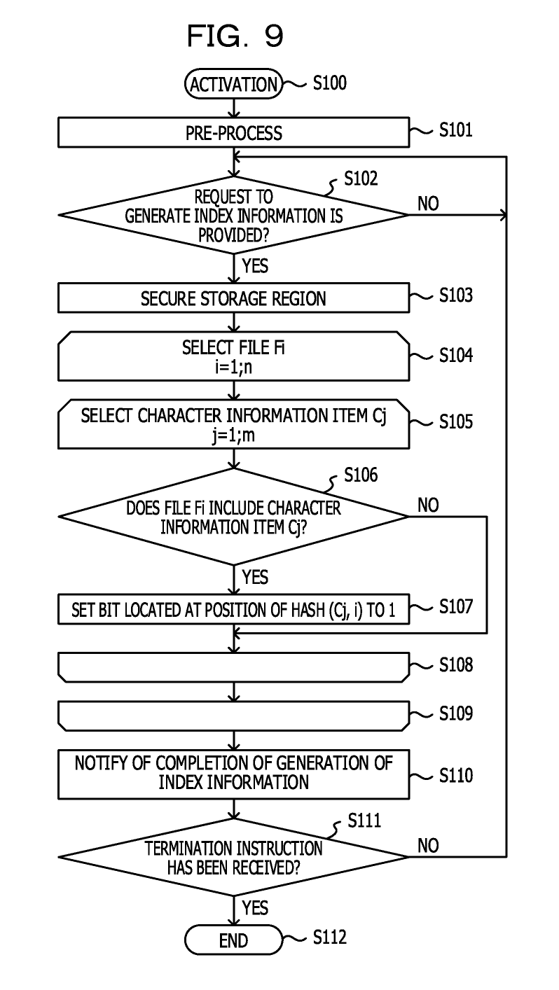

FIG. 9 illustrates an example of a procedure for a process of generating the index information item. When the index generation program 23a is activated (in S100), the control unit 131 executes a pre-process (in S101). The pre-process of S101 is, for example, reading of the table T1 illustrated in FIG. 12 and the character information items C1 to Cm and the like. The control unit 131 determines whether or not a request to generate the index information item is provided (in S102). The control unit 131 repeatedly makes the determination until the request to generate the index information item is provided (No in S102). If the request to generate the index information item is provided (Yes in S102), the control unit 131 secures a storage region for storing the index information item (in S103). For example, bits within the storage region secured in S103 are set to “0”.

The control unit 131 selects a file number i from the table T1 illustrated in FIG. 12 and causes the reading unit 132 to read a file Fi having the selected file number i (in S104). For example, in S104, the control unit 131 sequentially selects records within the table T1. Next, the determining unit 133 selects a single character information item Cj from among the character information items C1 to Cm (in S105). For example, in S105, the determining unit 144 may hold a list of the character information items C1 to Cm and sequentially select character information items included in the list or sequentially select character information items included in the list while incrementing a character code by a value in a predetermined range. The determining unit 133 determines whether or not the file Fi includes the character information item Cj (in S106). If the determining unit 133 determines that the file Fi includes the character information item Cj (Yes in S106), the control unit 131 calculates an address based on the file number i and the character information item Cj. The control unit 131 updates a bit located at a position associated with the calculated address to “1”. Specifically, the control unit 131 causes a logical sum (OR) of the bit located at the position associated with the calculated address and “1” to be stored at a position associated with the calculated address. When the control unit 131 updates the bit, the determining unit 133 executes a process of S108. If the determining unit 133 determines that the file Fi does not include the character information item Cj (No in S106), the determining unit 133 executes the process of S108. The process is executed on the next character information item. If an unselected character information item exists among the character information items C1 to Cm, the determining unit 133 executes the process of S105 again (in S108). If an unselected character information item does not exist among the character information items C1 to Cm, a process of S109 is executed. In S109, if an unselected file exists among the files F1 to Fn, the reading unit 132 executes the process of S104 again. If an unselected file does not exist among the files F1 to Fn, a process of S110 is executed.

The control unit 131 notifies that the process of generating the index information item of the files F1 to Fn has been completed (in S110). In S110, the control unit 131 stores, as an index file, information within the region secured in S103. After the process of S110, the processing unit 11 determines whether or not a termination instruction has been received (in S111). If the termination instruction has been received (Yes in S111), the processing unit 11 terminates the index generation program 23a. If the termination instruction has not been received (No in S111), the process of S102 is executed again.

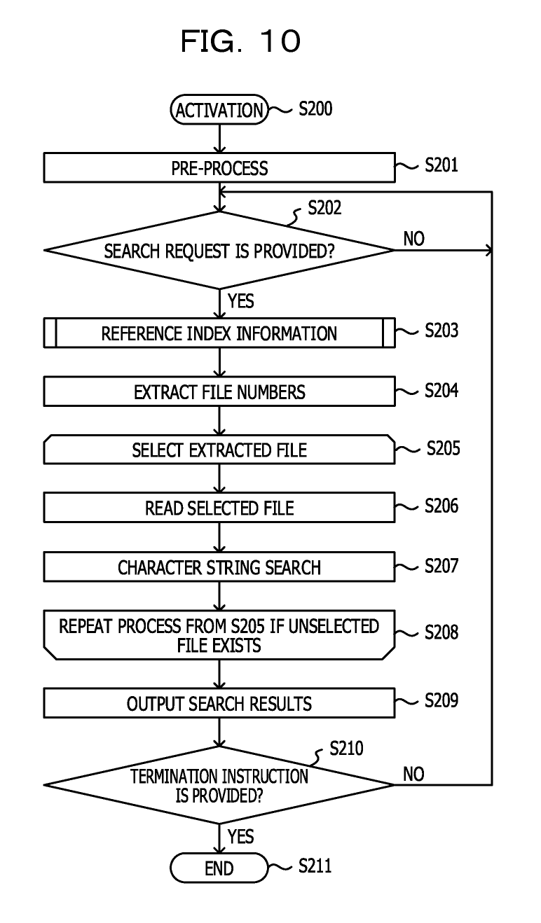

FIG. 10 illustrates an example of a procedure for a full-text search process. When the search processing program 23b is activated (in S200), the search control unit 14 executes a pre-process (in S201). The pre-process of S201 is reading of the table T1 illustrated in FIG. 12 and reading of the index information item. The search control unit 14 determines whether or not the search control unit 14 has received a search request (in S202). The search control unit 14 repeatedly makes the determination of S202 until the search control unit 14 receives the search request (No in S202). If the search control unit 14 has received the search request (Yes in S202), an index referencing process is executed (in S203).

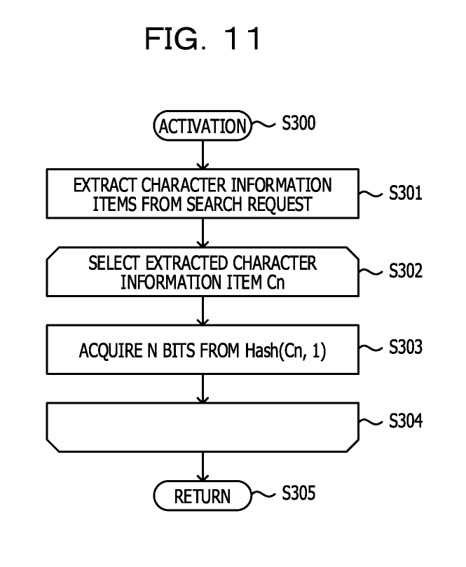

FIG. 11 illustrates an example of a procedure for the index referencing process. When S203 is executed (in S300), the search control unit 14 extracts a character string included in the search request and to be searched and extracts character information items Ca, Cb, . . . that are among the character information items C1 to Cm and included in the character string to be searched (in S301).

When the search control unit 14 extracts the character information items Ca, Cb, . . . , the narrowing-down unit 15 determines whether or not each of the files F1 to Fn is a file that does not include at least one of the extracted character information items Ca, Cb, . . . . Specifically, the narrowing-down unit 15 selects one of the extracted character information items Ca, Cb, . . . (in S302). The referencing unit 151 calculates an address based on the selected character information item and reads information stored at a position represented by the calculated address (in S303). In S303, the referencing unit 151 calculates the address in the same manner as calculation of S107. In this case, the referencing unit 151 calculates the address using the file number “1” and reads a bit string of n bits continuous from the calculated address. If an unselected character information item exists among the extracted character information items Ca, Cb, . . . , the narrowing-down unit 15 executes the process of S302 again. If an unselected character information item does not exist among the extracted character information items Ca, Cb, . . . , the narrowing-down unit 15 terminates the index referencing process (in S304 and S305).

When the index referencing process is terminated, the narrowing-down unit 15 extracts file numbers of files to be searched (in S204). In S204, the determining unit 152 calculates logical products (AND) of bit strings read by the referencing unit 151 for the character information items Ca, Cb, . . . , for example. The determining unit 152 generates a number representing the position of a bit of the value “1” within a bit string of the calculated logical products. For example, if an x-th bit and a y-th bit within the bit string of the calculated logical products have the value “1”, the determining unit 152 generates numbers x and y.

The search control unit 14 selects a number i from among the numbers x, y, . . . generated by the determining unit 152 (in S205). The character string search unit 16 reads a file Fi having the same file number as the selected number i (in S206). The character string search unit 16 reads the file from a storage position associated with the file number i in the table T1 illustrated in FIG. 12. The character string search unit 16 searches, from the file F1, the character string that is to be searched (in S207). For example, if the character string search unit 16 detects a character string included in the file Fi and matching the character string to be searched, the character string search unit 16 generates information representing the position of the matching character string within the file Fi, associates the generated information with the file number i of the file Fi, and causes the information and the file number i to be stored in the storage unit 12 (refer to FIG. 12). For example, a counter that is configured to count the amount of data crosschecked with the character string to be searched may be provided, and a value of the counter when the character string that matches the character string to be searched is detected is treated as the information representing the position of the character string within the file F1.

After the process of S207, if an unselected number exists among the numbers x, y, . . . generated by the determining unit 152, the search control unit 14 executes the process of S205. If an unselected number does not exist among the numbers x, y, . . . generated by the determining unit 152, the search control unit 14 executes a process of S210.

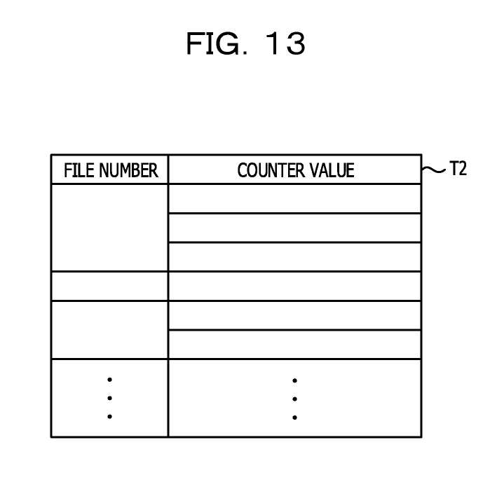

The search control unit 14 executes a process of outputting results of the search (in S209). For example, the search control unit 14 execute the process so as to extract a character string located near the position represented by the information stored in a table T2 illustrated in FIG. 13 in the process of S207 and causes the display device to display the extracted character string, the file name corresponding to the file number, and the like.

After the process of S209, the processing unit 11 determines whether or not the termination instruction has been provided (in S210). If the termination instruction has not been provided (No in S210), the search control unit 14 executes the process of S202. If the termination instruction has been provided (Yes in S210), the processing unit 11 terminates the search processing program 23b (in S211).

A method for calculating, based on a file number i and a character information item Cj, an address at which presence or absence information is stored is described below in detail. First, a method for treating, as an address, a remainder obtained by dividing a sum of the character information item Cj shifted by a bits and the file number by the divider D is described below.

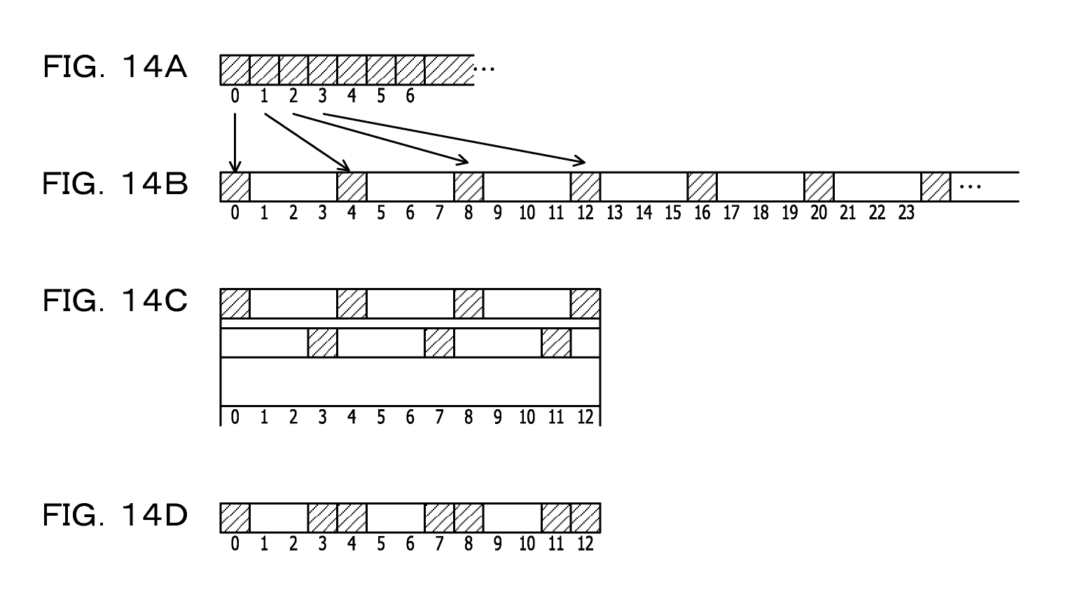

FIGS. 14A, 14B, 14C, and 14D are diagrams illustrating relationships between the divider D and the number α of bits to be shifted. It is assumed that numerical values 0 to 6 illustrated in FIG. 14A are associated with character information items (C0 to C6). FIG. 14A illustrates an example, and the numerical values correspond to binary codes of character information items that are each represented by 8 bits or 16 bits. FIG. 14B illustrates numerical values that are obtained by shifting the binary codes of the character information items C0 to C6 by 2 bits and are 0, 4, 8, 12, 16, 20, and 24. The numerical values illustrated in FIG. 14B are numerical values serving as arguments if the file number is “0”. FIG. 14C illustrates remainders and quotients that are obtained by dividing the numerical numbers illustrated in FIG. 14B by the divider D if the divider D is 13. The remainders are 0, 4, 8, 12, 3, and 7. FIG. 14D collectively illustrates the remainders illustrated in FIG. 14C. The numerical values illustrated in FIGS. 14A to 14D indicate addresses if the file number is “0”. The numerical values are 0, 4, 8, 12, 3, and 7 and are not the same value. Addresses at which presence or absence information that represents whether or not the character information items C0 to C6 exist in the file with the file number “0” is stored are different from each other. For example, even if the file number is i, the addresses are only shifted based on the number i. Thus, addresses at which the presence or absence information that represents whether or not the character information items C0 to C6 exist in the file Fi is stored are different from each other.

For example, if a character information item C13 corresponding to “13” exists, a remainder obtained by dividing an argument of (13×4) by “13” is 0, and an address of the character information item C13 is the same as the character information item C0. Different addresses are assigned to character information items C0 to C12.

The number of types of addresses at which presence or absence information that represents whether or not character information items exist in the same file is determined by the least common multiple X of the α-th power of 2 and the divider D. A value Y obtained by dividing the least common multiple X by the α-th power of 2 is the number of types of addresses to be obtained. If the α-th power of 2 and the divider D are coprime to each other, the divider D is equal to the number of types of addresses to be obtained. It is sufficient if the divider D is an odd number as a number coprime to the α-th power of 2.

In the aforementioned example, if the divider D is 12, the least common multiple X of the α-th power (=4) of 2 and the divider D is 12 and the value Y obtained by dividing the least common multiple X by the α-th power of 2 is 3. Remainders, which are obtained by dividing, by 12, the numerical values 0, 4, 8, 12, 16, 20, and 24 obtained by shifting the binary codes of the character information items C0 to C6 by 2 bits, are 0, 4, 8, 0, 4, 8, 0, . . . , and addresses are of three types.

The size of the index information item is a value obtained by multiplying a number k of values to be obtained by calculation using a hash function by the number (number n of the files) of bits. In this case, presence or absence information that represents whether or not a character information item exists in the same file is stored at a position represented by any of addresses of types of which the number is k. If the divider D is equal to or nearly equal to a value of (k×n) and coprime to the α-th power of 2, presence or absence information that represents whether or not a character information item exists in the same file is stored at a position represented by any of addresses of types of which the number is equal to or nearly equal to the value of (k×n). Since an address that is among addresses of approximately n types and at which presence or absence information that represents whether or not a character information item exists in the same file is stored is determined in the index information item of which the size is nearly equal to a conventional index information item, character information items are hardly stored at positions that overlap each other.

However, in the example illustrated in FIGS. 14A to 14D, the character information items C0 to C6 exist, but not all character information items corresponding to all integers in a predetermined range exist. Thus, a degree of overlapping varies depending on a distribution of binary codes of a character set to be used. Since the size of the index information item is determined by the divider D, the divider D is set to a prime close to the size of the index information item, for example. If the character codes are shifted by the predetermined number α of bits, odd numbers are coprime to the α-th power of 2. Thus, an odd number that is close to the size of the index information item or the like is set as the divider D.

The number α of bits by which the binary codes of the character information items are shifted in order to generate arguments is additionally described below. In the above description, α is 16, but may be 4. However, if the number of file numbers is equal to or larger than a value able to be represented by 4 bits, arguments may overlap each other. For example, an argument for a file number 17 and a character information item Cj is the same as an argument for a file number 1 and a character information item Ck (Ck=Cj+1) of which a binary code is different by 1 from the character information item Cj. In addition, α may be set to 0 and a sum of the binary code of the character information item Cj and the file number may be used. An argument for the file number “1” and the character information item Cj is different by 1 from the argument for the file number “1” and the character information item Ck (Ck=Cj+1).

In the aforementioned first embodiment, the arguments are generated by shifting the binary codes of the character information items, and the function for calculating remainders is used as the function f into which the arguments are substituted. Both methods may be changed to other methods. For example, the file numbers may be shifted instead of the character information items in the generation of the arguments. In addition, only a part of the binary codes of the character information items may be combined with the file numbers. Furthermore, a function that outputs values in a predetermined range may be used as the function f instead of the function for calculating remainders, for example. Arguments may be divided into parts each having a predetermined number of digits, and a function for calculating a sum of values obtained by the division may be used. In the aforementioned modified examples, the referencing unit 151 calculates an address for each of the files and reads presence or absence information bit by bit in the process of S203 illustrated in FIG. 10.

### Second Embodiment

A second embodiment is described below. In the second embodiment, a plurality of index information items are used. Bit strings (with a bit length n) that are associated with a character information item Cj included in a character string to be searched are extracted from the plurality of index information items, and the files are narrowed down to files to be subjected to the character string search, based on results of calculating logical products (AND) of the extracted bit strings.

If the index information items are generated based on addresses obtained by different functions f and used, combinations (of the file Fi and the character information item Cj) that are associated with the same address are different. It is assumed that if functions for calculating remainders are used as functions f1 and f2, a divider D1 to be used for the function f1 is different from a divider D2 to be used for the function f2. For example, the dividers D1 and D2 are integers that are coprime to each other.

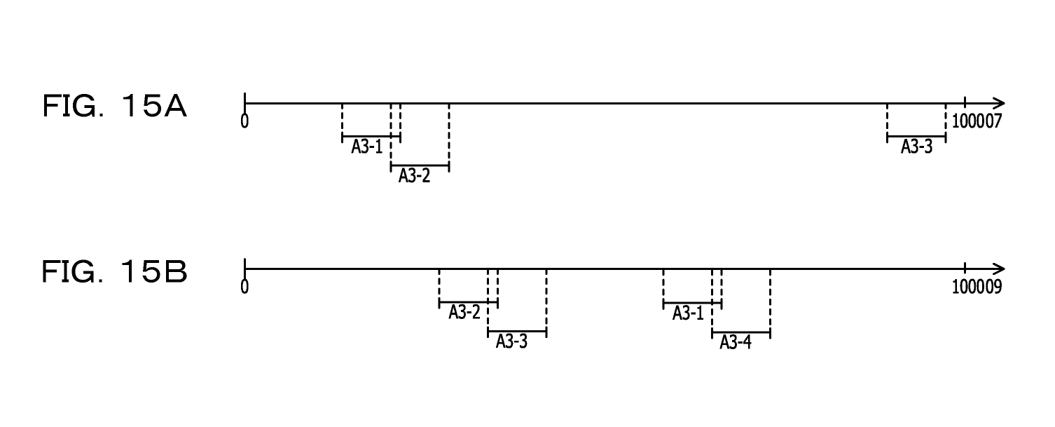

FIGS. 15A and 15B illustrate relationship of index information items for which the different functions f1 and f2 are used. FIG. 15A illustrates relationships between a range of numerical values of an index information item and the bit strings A3-1, A3-2, and A3-3. FIG. 15B illustrates relationships between a range of numerical values of an index information item and the bit strings A3-1, A3-2, and A3-3 in the index information item generated based on the function f2 different from the function f1 used for the index information item illustrated in FIG. 15A. As illustrated in FIG. 15A, a part of a range in which presence or absence information included in the bit string A3-1 is reflected in the index information item overlaps a part of a range in which presence or absence information included in the bit string A3-2 is reflected in the index information item. As described above, presence or absence information that represents whether or not the character information item “ [symbol] ” exists in the file F4086, and presence or absence information that represents whether or not the character information item “ [symbol] ” exists in the file F1, are reflected in the overlapping part, for example. On the other hand, in the index information item illustrated in FIG. 15B, a range in which the bit string A3-1 is reflected does not overlap a range in which the bit string A3-2 is reflected. Thus, presence or absence information that represents whether or not the character information item “ [symbol] ” exists, and presence or absence information that represents whether or not the character information item “ [symbol] ” exists, are reflected in different parts within the index information item. However, a part of a range in which the bit string A3-1 is reflected overlaps a part of a range in which a bit string A3-4 is reflected. The bit string A3-4 indicates presence or absence information that represents whether or not a character information item other than the character information items “ [symbol] ”, “ [symbol] ”, and “ [symbol] ” exists in the files F1 to Fn. In this case, presence or absence information that overlaps the presence or absence information representing whether or not the character information item “ [symbol] ” exists in the file F4086 and is reflected in the index information item illustrated in FIG. 15B may not be presence or absence information representing whether or not a character information item exists in the file F1, unlike the overlapping part illustrated in FIG. 15A, and may be presence or absence information representing whether or not a character information item exists in another file in many cases. If a file that includes a large number of types of character information items exists, a range in which the file is reflected overlaps a range in which the aforementioned other file is reflected, and the overlapping suppresses the fact that information that represents that a character information item is not included exists in the index information item.

### Third Embodiment

A third embodiment is described below. In an index information item according to the third embodiment, bit strings that are associated with character information items Cj are defined based on the character information items Cj, and positions at which presence or absence information is stored and that are within the bit strings are defined based on the character information items Cj and the file numbers.

For example, a bit string that is associated with a character information item Cj is represented by an address Y obtained by substituting a binary code of the character information item Cj into a function f. When the address Y is represented by an equation, Y=f(Cj). The function f is a function for calculating a remainder obtained by division by the divider D, or f(Cj)=mod(Cj, D) or the like.

It is assumed that each of positions at which presence or absence information is stored and that are within a bit string is represented by a sum of a file number i and an integral quotient obtained by dividing a binary code of a character information item Cj by the divider D. When a position X within the bit string is represented by an equation, X=i+QUOTIENT(Cj/D) or the like, where QUOTIENT is an operator for extracting an integral quotient that is a result of the division.

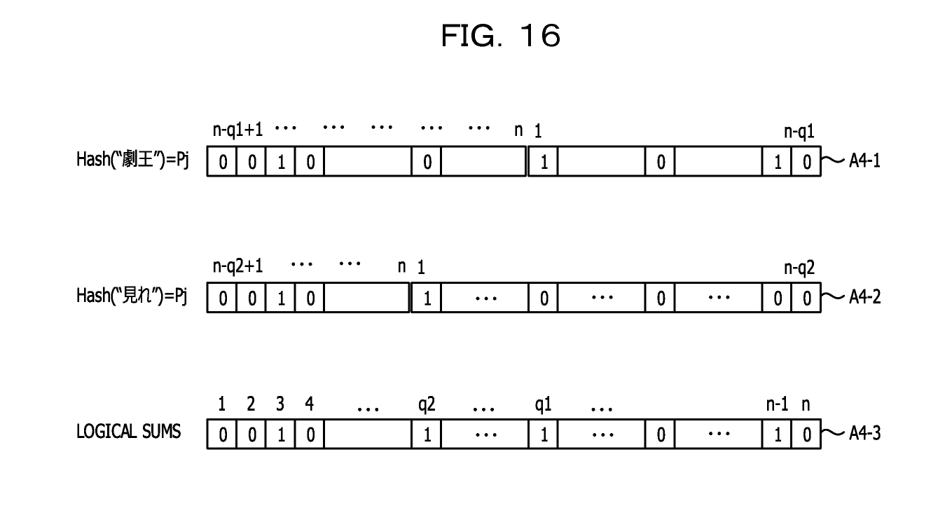

FIG. 16 illustrates an example of bit strings within the index information item according to the third embodiment. A bit string A4-1 indicates an example of presence or absence information that represents whether or not the character information item “ [symbol] ” exists. An address Y1 is obtained by substituting a binary code of the character information item “ [symbol] ” into a hash function. If q1=QUOTIENT(“ [symbol] ”/D), the bit string A4-1 is a bit string in which presence or absence information that represents whether or not the character information item “ [symbol] ” exists in the files F1 to Fn is shifted by q1 bits. A bit string A4-2 indicates an example of presence or absence information that represents whether or not the character information item “ [symbol] ” exists. An address Y2 is obtained by substituting a binary code of the character information item “ [symbol] ” into the hash function. If q2=QUOTIENT(“ [symbol] ”/D), the bit string A4-2 is a bit string in which presence or absence information that represents whether or not the character information item “ [symbol] ” exists in the files F1 to Fn is shifted by q2 bits. As illustrated in FIG. 16, if the address of the character information item “ [symbol] ” matches the address of the character information item “ [symbol] ” (Y1=Y2), the bit string of Y1 (or Y2) within the index information item is a bit string A4-3 of logical sums (OR) of bits of the bit string A4-1 and bits of the bit string A4-2.

The character information items are shifted by an integral quotient obtained by division by the divider D. Thus, if character information items of which addresses Y are the same value exist, numbers by which presence or absence information that represents whether or not the character information items exist is shifted are different. Thus, if the difference between the numbers by which the information is shifted is not a multiple of the number n of the files, presence or absence information that represents whether or not the character information items exist in the same file is stored at different positions within a bit string. In the example illustrated in FIG. 16, presence or absence information that represents whether or not the character information item “ [symbol] ” exists in the file Fi, and presence or absence information that represents whether or not the character information item “ [symbol] ” exists in the file Fi, are stored at different positions within a bit string. Thus, regardless of the fact that the file Fi does not include the character information item “ [symbol] ”, the following fact is suppressed: the index information item does not represent the absence of the character information item “ [symbol] ” due to the presence of the character information item “ [symbol] ” in the file Fi.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method comprising:
storing, by a processor, in a storage region represented by first character information and identification information of a first file, presence or absence information that represents whether or not the first file includes the character information or whether or not a second file that is different from the first file includes second character information,
wherein the storage region stores information that represents whether or not the second file includes the second character information.

2. The method according to claim 1, wherein the second character information is different from the first character information.

3. The method according to claim 1, wherein the size of the first file is larger than the second file.

4. The method according to claim 1, further comprising:
storing, in another storage region represented by the first character information and the identification information, other presence or absence information that represents whether or not the first file includes the first character information or whether or not the second file includes the second character information,
wherein the other storage region stores information that represents whether or not a third file that is different from the first file and the second file includes third character information.

5. The method according to claim 1, wherein the storage region is represented by a first numerical value calculated based on the first character information and the identification information, and
the method further comprising:
storing, in another storage region represented by a second numerical value, other presence or absence information that represents whether or not a fourth file that is different from the first file includes the first character information, the second numerical value being calculated based on identification information of the fourth file and the first character information and being next to the first numerical value.

6. The method according to claim 5, wherein the second numerical value is larger than the first numerical value.

7. The method according to claim 1, wherein the storage region is represented by a value obtained by substituting, into a predetermined function, an argument obtained by converting the first character information and the identification information.

8. The method according to claim 7, wherein
the argument is obtained by a sum of the identification information and information obtained by executing predetermined conversion on the first character information, and
the predetermined function is a function for calculating a remainder obtained by dividing the sum by a predetermined number.

9. A search method comprising:
reading presence or absence information from a storage region represented by first character information and identification information of a first file when a search request that includes the first character information is received; and
searching, by a processor, the first character information from the first file when the presence or absence information represents that the first file includes the first character information or that a second file that is different from the first file includes second character information.

10. The search method according to claim 9, wherein the second character information is different from the first character information.

11. The search method according to claim 9, wherein the size of the first file is larger than the second file.

12. The search method according to claim 9, wherein
other presence or absence information is stored in another storage region represented by the first character information and the identification information, the other presence or absence information representing whether or not the first file includes the first character information or whether or not the second file includes the second character information, and
the other storage region stores information that represents whether or not a third file that is different from the first file and the second file includes third character information.

13. The search method according to claim 9, wherein
the storage region is represented by a first numerical value calculated based on the first character information and the identification information, and
other presence or absence information is stored in another storage region represented by a second numerical value, the other presence or absence information representing whether or not a fourth file that is different from the first file includes the first character information, the second numerical value being calculated based on identification information of the fourth file and the first character information and being next to the first numerical value.

14. The search method according to claim 13, wherein the second numerical value is larger than the first numerical value.

15. The search method according to claim 9, wherein the storage region is represented by a value obtained by substituting, into a predetermined function, an argument obtained by converting the first character information and the identification information.

16. The search method according to claim 15, wherein
the argument is obtained by a sum of the identification information and information obtained by executing predetermined conversion on the first character information, and
the predetermined function is a function for calculating a remainder obtained by dividing the sum by a predetermined number.

17. A non-transitory computer-readable recording medium storing a program that causes a computer execute a process, the process comprising:
reading presence or absence information from a storage region represented by first character information and identification information of a first file when a search request that includes the first character information is received; and
searching the first character information from the first file when the presence or absence information represents that the first file includes the first character information or that a second file that is different from the first file includes second character information.

18. The non-transitory computer-readable recording medium according to claim 17, wherein the second character information is different from the first character information.

19. The non-transitory computer-readable recording medium according to claim 17, wherein the size of the first file is larger than the second file.

20. The non-transitory computer-readable recording medium according to claim 17, wherein
other presence or absence information is stored in another storage region represented by the first character information and the identification information, the other presence or absence information representing whether or not the first file includes the first character information or whether or not the second file includes the second character information, and
the other storage region stores information that represents whether or not a third file that is different from the first file and the second file includes third character information.
